(19) United States
(12) Patent Application Publication
(10) Pub. No.: US 2025/0003670 A1
(43) Pub. Date: Jan. 2, 2025

(54) HINGE AND BUILT-IN REFRIGERATOR HAVING THE SAME

(71) Applicants: QINGDAO HAIER REFRIGERATOR CO., LTD., Qingdao, Shandong (CN); HAIER SMART HOME CO., LTD., Qingdao, Shandong (CN)

(72) Inventors: Changzhi WANG, Qingdao, Shandong (CN); Enpin XIA, Qingdao, Shandong (CN); Qiufang LI, Qingdao, Shandong (CN); Kang LI, Qingdao, Shandong (CN); Yufeng DONG, Qingdao, Shandong (CN)

(21) Appl. No.: 18/691,754

(22) PCT Filed: Jul. 14, 2022
(86) PCT No.: PCT/CN2022/105742

§ 371 Date: Mar. 13, 2024

(30) Foreign Application Priority Data
Sep. 15, 2021 (CN) 202111080960.X

(51) Int. Cl. F25D 23/02; E05D 3/18; F25D 23/10

(52) U.S. Cl. CPC F25D 23/028; E05D 3/186; F25D 23/10; F25D 2323/024

(57) ABSTRACT

A hinge includes a fixed seat mounted on the cabinet, a movable seat mounted on the door, and a linkage assembly hinged between the fixed and movable seats. One of the movable or fixed seat is provided with a guide groove that cooperates with the linkage assembly, at least one portion of the guide groove is a curved groove. This configuration allows for the control of the door's movement trajectory according to specific needs.

### CROSS-REFERENCE TO RELATED APPLICATIONS

The present application is a national phase entry of International Application No. PCT/CN2022/105742, filed Jul. 14, 2022, which claims priority to Chinese Patent Application No. CN202111080960.X, filed Sep. 15, 2021, which are incorporated herein by reference in their entirety.

### FIELD OF THE INVENTION

Present application relates to the field of home appliances, and in particular to a hinge and a built-in refrigerator having same.

### BACKGROUND OF THE INVENTION

With the progress of society and the improvement of people's living standards, the placement and installation style of refrigerators in homes have become increasingly important to users. While for the current style of home decoration, some families pursue integration of style, it will be necessary to put the refrigerator into the cupboard, constituting the so-called built-in refrigerator device.

For the built-in refrigerator device, during the process of the door rotating open around the hinge axis, the side of the door hinged to the cabinet, often protrudes beyond the side wall of the cabinet, leading to collisions between the door and the cupboard wall or cupboard door. This not only affects the magnitude of opening of the refrigerator door, but also damages the surface of the refrigerator door, affects its aesthetics. That is, it is difficult for the current refrigerators to adapt to this built-in application scenarios.

Therefore, it is necessary to improve existing hinges and built-in refrigerators having such a hinge, to solve the above problem.

Reference to any prior art in the specification is not, and should not be taken as, an acknowledgment or any form of suggestion that this prior art forms part of the common general knowledge in Europe or any other jurisdiction or that this prior art could reasonably be expected to be understood and regarded as relevant by a person skilled in the art.

### BRIEF DESCRIPTION OF THE INVENTION

The purpose of this Present application is to provide a hinge and a built-in refrigerator having such a hinge.

In order to achieve one of the above objects of the application, the present application provides a hinge, comprising a fixed seat mounted on a cabinet, a movable seat mounted on a door, and a linkage assembly hinged between the fixed seat and the movable seat; one of the movable seat and the fixed seat is provided with a guide groove, and at least one portion of the guide groove is a curved groove, and during the rotation of the movable seat relative to the fixed seat, the linkage assembly moves along the guide groove.

In order to achieve the above objects of the application, the present application also provides a hinge, comprising a fixed seat mounted on a cabinet, a movable seat mounted on a door, and a linkage assembly hinged between the fixed seat and the movable seat; one of the movable seat and the fixed seat is provided with a guide groove that cooperates with the linkage assembly, and during the rotation of the movable seat relative to the fixed seat, the guide groove is used to guide the movable seat to move along intersecting first and second directions simultaneously; the movement ratio between displacements in the first direction and displacements in the second direction changes with the rotation angle of the movable seat.

As a further improvement of the present application, during the opening rotation of the movable seat relative to the fixed seat, the movement ratio between the displacement in the first direction and the displacement in the second direction gradually increases.

As a further improvement of the present application, during the opening rotation of the movable seat relative to the fixed seat, the movement ratio between the displacement in the first direction and the displacement in the second direction gradually decreases.

As a further improvement of the present application, the first direction is a forward direction of the fixed seat towards the movable seat, and the second direction is a lateral direction towards the pivot side of the hinge, the first direction is perpendicular to the second direction.

As a further improvement of the present application, the guide groove is located on the movable seat; the portion of the guide groove away from the pivot side of the hinge is a convex curved groove, and the convex curved groove extends from the end away from the pivot side towards the pivot side and towards the fixed seat.

As a further improvement of the present application, the portion of the guide groove near the pivot side of the hinge is a straight groove, the convex curved groove is connected to the straight groove.

As a further improvement of the present application, the linkage assembly comprises:
a first rocker, the rotating end of the first rocker is rotatably connected to the fixed seat, and the swinging end of the first rocker is slidably connected in the guide groove;
a second rocker, the rotating end of the second rocker is rotatably connected to the fixed seat;
a third rocker, the rotating end of the third rocker is rotatably connected to the movable seat, and the swinging end of the third rocker is rotatably connected to the swinging end of the second rocker, and the third rocker crosses the first rocker and is rotatably connected at the crossing point.

As a further improvement of the present application, the rotating end of the second rocker is located on the side of the first rocker's rotating end that is away from the movable seat.

As a further improvement of the present application, the guide groove is located on the fixed seat; the guide groove is a convex curved groove that extends from the end away from the pivot side of the hinge towards the pivot side and towards the movable seat.

As a further improvement of the present application, the guide groove is located on the fixed seat; the guide groove is a concave curved groove that extends from the end away from the pivot side of the hinge towards the movable seat and towards the pivot side.

As a further improvement of the present application, the guide groove is located on the fixed seat; the linkage assembly comprises:
a first rocker, the rotating end of the first rocker is rotatably connected to the movable seat, and the swinging end of the first rocker is slidably connected in the guide groove;
a second rocker, the rotating end of the second rocker is rotatably connected to the movable seat;
a third rocker, the rotating end of the third rocker is rotatably connected to the fixed seat, and the swinging end of the third rocker is rotatably connected to the swinging end of the second rocker, and the third rocker crosses the first rocker and is rotatably connected at the crossing point.

As a further improvement of the present application, the end of the guide groove away from the pivot side of the hinge is located on the side of the third rocker's rotating end that is away from the movable seat.

As a further improvement of the present application, the movable seat or the fixed seat provided with the guide groove has a containment cavity, which is used to accommodate the linkage assembly in a folded state.

As a further improvement of the present application, the hinge comprises two sets of the linkage assembly disposed within the fixed seat and arranged side by side along the height direction of the fixed seat, and two movable seats respectively cooperating with the two sets of the linkage assembly.

As a further improvement of the present application, the rotating shafts connected to the fixed seat and coaxial with each other in the two sets of linkage assembly are connected together by a sleeve.

In order to achieve the above objects of the application, the present application also provides a built-in refrigerator, comprising a cabinet, a door, a hinge as described above.

Compared with the existing technology, the beneficial effects of this application are: the hinge of this application, by setting at least a portion of the guide groove as a curved groove, during the rotation of the movable seat relative to the fixed seat, the movement ratio between the displacement in the first direction and the displacement in the second direction changes with the rotation angle of the movable seat. Thus, it is possible to adjust the displacement of the door in the first and second directions according to specific needs during the door opening process, and to control the movement trajectory of the door, so as to enable the door to adapt to a variety of application scenarios.

As used herein, except where the context clearly requires otherwise, the term “comprise” and variations of the term, such as “comprising”, “comprises” and “comprised”, are not intended to exclude further features, components, integers or steps.

### BRIEF DESCRIPTION OF THE DRAWINGS

FIG. 1 is a schematic structure diagram of a refrigerator in the present application;

FIG. 2 is a schematic structure diagram of the hinge in the first embodiment of this application (linkage assembly is in a folded state);

FIG. 3 is a schematic structure diagram of the hinge in the first embodiment of this application (linkage assembly is in an unfolded state);

FIG. 4 is a schematic structure diagram of the hinge in the second embodiment of this application (linkage assembly is in a folded state);

FIG. 5 a schematic structure diagram of the hinge in the second embodiment of this application (linkage assembly is in an unfolded state);

FIG. 6 is a schematic structure diagram of the hinge in the third embodiment of this application (linkage assembly is in a folded state);

FIG. 7 is a schematic structure diagram of the hinge in the third embodiment of this application (linkage assembly is in an unfolded state).

### DETAILED DESCRIPTION

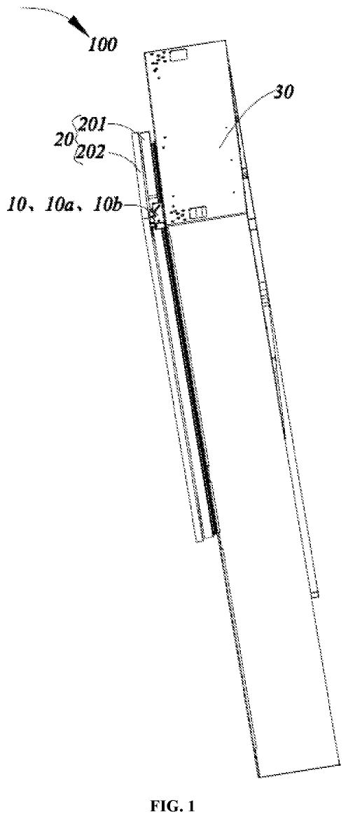

The specific embodiments of the present application will be described in detail below with reference to FIGS. 1-7. However, these embodiments do not limit the application. Structural, methodological, or functional changes made by those of ordinary skill in the art based on these embodiments are encompassed within the scope of protection of this application.

The terms used in this present application to describe positions and directions are based on the side of the refrigerator door during normal use as “front,” and the direction away from the refrigerator on the pivot side as “outside.” For example, in a French doors refrigerator, the movement of one door away from the other door from the pivot side during the opening process is considered an outward movement, and the movement towards the other door from the pivot side during the opening process is considered an inward movement. The terms “first,” “second,” “third,” etc., in this application are used only for descriptive purposes and should not be construed as indicating or implying relative importance or suggesting the number of technical features indicated; furthermore, it should be noted that, unless otherwise explicitly specified and limited, the term “connected” should be understood in a broad sense. For example, a connection can be a direct connection or an indirect connection through an intermediary medium, it can be a fixed connection or a movable connection, or it can be a detachable connection or an integral connection. Those of ordinary skill in the art can understand the specific meanings of the above terms in this invention based on the circumstances.

Referring to FIG. 1, present application provides a hinge 10, the hinge 10 is used to connect a door 20 to a cabinet 30. In this embodiment, the hinge 10 is applied to a built-in refrigerator 100, and the door 20 of the refrigerator 100 opens by rotating left or right as a specific example for detailed explanation.

Of course, it is important to emphasize that the hinge 10 of this embodiment is not only suitable for refrigerator 100 but can also be applied to other scenarios, such as cupboards, wine cabinets, closets, microwave ovens, and other home appliances.

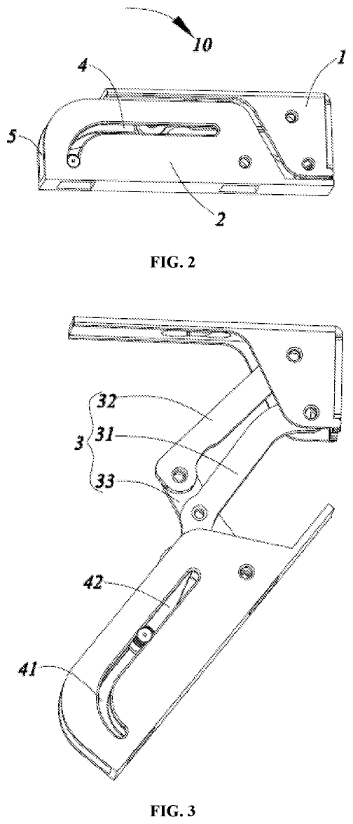

Please refer to FIG. 2—and FIG. 3, the hinge 10 comprises a fixed seat 1 mounted on the cabinet 30, a movable seat 2 mounted on the door 20, and a linkage assembly 3 hinged between the fixed seat 1 and the movable seat 2. One of the movable seat 2 and the fixed seat 1 is provided with a guide groove 4. During the rotation of the movable seat 2 relative to the fixed seat 1, the linkage assembly 3 cooperates with the guide groove 4, that is, one end of the linkage assembly 3 moves along the guide groove 4 to make the movable seat 2 move along a predetermined trajectory relative to the fixed seat 1, that is, to make the door 20 move along a predetermined trajectory.

When the door 20 is in a closed state, the linkage assembly 3 is in a folded state, at which time the movable seat 2 is close to the fixed seat 1. When opening the door 20, i.e., when the door 20 moves in the direction away from the cabinet 30, the linkage assembly 3 gradually extends from the folded state to the unfolded state. During the process of closing the door 20, i.e., when the door 20 moves towards the cabinet 30, the door 20 is in a closed state after the linkage assembly 3 gradually contracts from the unfolded state to the folded state.

It can be understood that, as the door 20 rotates away from the cabinet 30, the movable seat 2 rotates away from the fixed seat 1 in the direction away from the fixed seat 1.

Further, the aforementioned predetermined trajectory refers to during the rotation process of the movable seat 2 relative to the fixed seat 1, the movable seat 2 moving simultaneously along intersecting first and second directions under the guidance of the guide groove 4. Moreover, the movement ratio between the displacement in the first direction and the displacement in the second direction changes with the rotation angle of the movable seat 2. This allows for adjustment of the displacement of the door 20 in the first and second directions during the opening process, to control the movement trajectory of the door 20.

Specifically, the first direction is a forward direction of the fixed seat 1 towards the movable seat 2, and the second direction is a lateral direction towards the pivot side of the hinge 10, the first direction is perpendicular to the second direction. In other words, the first direction is the front of the refrigerator 100, and the second direction is outward from the pivot side of the refrigerator 100, and the second direction is an outward direction of the refrigerator 100 located on the pivot side. On one hand, during the opening process of the door 20, the pivot end of the door 20 gradually moves to the front side of the wall/cupboard at the pivot side, thereby avoiding interference with the wall/cupboard at the pivot side during the door opening process and allowing the door 20 to adapt to various application scenarios, such as the application scenario of a built-in refrigerator 100; On the other hand, by moving the pivot end of the door 20 outward during the opening process, the opening angle of the door 20 is increased, facilitating the user's ability to view and access items inside the cabinet 30.

Furthermore, in a specific embodiment, during the opening rotation of the movable seat 2 relative to the fixed seat 1, the movable seat 2 is set so that the movement ratio between the displacement in the first direction and the displacement in the second direction gradually increases. Thus, during the first stage of opening the door 20, the main movement of the door 20 is outward, at which time, both the rotation angle and the forward distance of the door 20 are smaller, avoiding interference between this door 20 and another door 20 in a French door refrigerator 100 during the opening process. In the second stage of opening the door 20, the main movement of the door 20 is forward, at which time the rotation angle and the outward distance are smaller, preventing interference between the door 20 and walls/cupboards at the pivot side. In the third stage of opening the door 20, the main movement of the door 20 is rotational, at which time both the forward and outward distances are smaller, to further increase the opening angle of the door 20, facilitating the user's ability to view and access items inside the cabinet 30.

In another specific embodiment, during the opening rotation of the movable seat 2 relative to the fixed seat 1, the movable seat 2 is set so that the movement ratio between the displacement in the first direction and the displacement in the second direction gradually decreases. Consequently, during the first stage of opening the door 20, the main movement of the door 20 is forward, at which time, both the rotation angle and the outward distance of the door 20 are smaller. It can be understood that, after the door 20 moves forward a certain distance, when it continues to rotate away from the cabinet 30, the likelihood of interference with walls/cupboards at the pivot side is reduced, thus avoiding interference between the door 20 and walls/cupboards at the pivot side. In the second stage of opening the door 20, the main movement of the door 20 is outward, at which time, the forward distance of the door 20 is smaller, reducing the space requirement in front of the refrigerator 100 during the opening process. In the third stage of opening the door, the main movement of the door 20 is rotational, at which time, both the forward and outward distances are smaller, to further increase the opening angle of the door 20, facilitating the user's ability to view and access items inside the cabinet 30.

Further, at least one portion of the guide groove 4 is a curved groove. It is understood that each point of the curved groove has a different curvature. By changing the size of the curvature, the trend of curvature change, the shape, etc., it is possible to adjust the relationship between the rotation angle, the forward distance, and the outward distance of the door 20 during the opening process. That is, to enable the movable seat 2 to drive the door 20 so that the movement ratio between the displacement in the first direction and the displacement in the second direction changes with the rotation angle of the movable seat 2, to avoid interference with walls/cupboards at the pivot side during the door opening process, and to increase the opening angle of the door 20, facilitating the user's ability to view and access items inside the cabinet 30.

Referring to FIG. 2-FIG. 3, in the first embodiment of present application, the guide groove 4 is located on the movable seat 2. The portion of the guide groove 4 away from the pivot side of the hinge 10 is a convex curved groove 41, and the convex curved groove 41 extends from the end away from the pivot side towards the pivot side and towards the fixed seat 1, meaning that the curvature of the convex curved groove 41 gradually decreases as it approaches the pivot side.

When the door 20 is in a closed state, the end of the linkage assembly 3 that cooperates with the guide groove 4 is positioned at the end of the convex curved groove 41 that is away from the pivot side. During the door opening process, the end of the linkage assembly 3 that cooperates with the guide groove 4 moves along the convex curved groove 41 to control the initial movement trajectory of the door 20, to avoid interference with walls/cupboards at the pivot side during the door opening process.

Specifically, in the embodiment, the curvature of the convex curved groove 41 gradually decreases as it approaches the pivot side, during the end of the linkage assembly 3 that cooperates with the guide groove 4 moves from the end of the convex curved groove 41 away from the pivot side towards the pivot side, the movement ratio between the displacement in the first direction and the displacement in the second direction decreases progressively with the increase of the rotation angle of the movable seat 2. Consequently, during the first stage of opening the door 20, the curvature of the convex curved groove 41 is lager, the main movement of the door 20 is forward, and both the rotation angle and the outward distance of the door 20 are smaller. It is understood that, after the door 20 moves forward a certain distance, when it continues to rotate away from the cabinet 30, the likelihood of interference with walls/cupboards at the pivot side is reduced, thus preventing interference between the door 20 and walls/cupboards at the pivot side. In the second stage of opening the door 20, the curvature of the convex curved groove 41 is smaller, the main movement of the door 20 is outward, at which time, the forward distance of the door 20 is smaller, reducing the space requirement in front of the refrigerator 100 during the opening process.

Furthermore, the portion of the guide groove 4 near the pivot side of the hinge 10 is a straight groove 42, the convex curved groove 41 is connected to the straight groove 42. In the third stage of opening the door 20, the end of the linkage assembly 3 that cooperates with the guide groove 4 moves along the straight groove 42 towards the pivot side. At which time, the main movement of the door 20 is rotational, and both the forward and outward movements are smaller, which can increase the opening angle of the door 20, make it easier for users to view and access items inside the cabinet 30.

In this embodiment, the guide groove 4 is L-shaped, but this is not limited to such a shape.

Further, the linkage assembly 3 comprises a first rocker 31, a second rocker 32, and a third rocker 33. The rotating end of the first rocker 31 is rotatably connected to the fixed seat 1, and the swinging end of the first rocker 31 is slidably connected in the guide groove 4. The rotating end of the second rocker 32 is rotatably connected to the fixed seat 1. The rotating end of the third rocker 33 is rotatably connected to the movable seat 2, and the swinging end of the third rocker 33 is rotatably connected to the swinging end of the second rocker 32, and the third rocker 33 crosses the first rocker 31 and is rotatably connected at the crossing point. That is, the linkage assembly 3, fixed seat 1, and movable seat 2 together form a five-bar linkage structure.

The linkage assembly 3 forms a long force arm, which allows the door 20 to move forward to a position far from the front end of the cabinet 30 during the opening process. Therefore, after applying the hinge 10 to a built-in refrigerator 100, the door 20 of the built-in refrigerator 100 can easily move to the front end of the wall/cupboard at the pivot side during the opening process, effectively avoiding interference between the door 20 and the wall/cupboard at the pivot side.

Specifically, the rotating end of the second rocker 32 is located on the side of the first rocker's 31 rotating end that is away from the movable seat 2, enabling the linkage assembly 3 to switch between the folded and unfolded states. That is, the linkage assembly 3 can control the transition of the door 20 between the closed and open states and control the movement trajectory of the door 20.

Further, the movable seat 2 has a containment cavity 5 open towards the fixed seat 1. This containment cavity 5 is used to accommodate the linkage assembly 3 in its folded state, enhancing the appearance of the refrigerator 100.

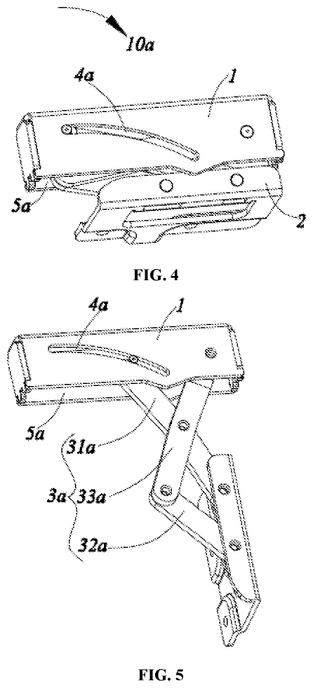

Please refer to FIG. 4-FIG. 5, shows a hinge 10a in the second embodiment of present application. The difference between the second embodiment and the first embodiment is that: the guide groove 4a is located on the fixed seat 1, and the guide groove 4a is a convex curved groove that extends from the end away from the pivot side of the hinge 10a towards the pivot side and towards the movable seat 2.

In a specific embodiment, the entire guide groove 4a is curved groove.

Specifically, the curvature of the convex curved groove 41 gradually increases as it approaches the pivot side. during the end of the linkage assembly 3 that cooperates with the guide groove 4 moves from the end of the convex curved groove 41 away from the pivot side towards the pivot side, the movement ratio between the displacement in the first direction and the displacement in the second direction increases progressively with the increase of the rotation angle of the movable seat 2. Therefore, in the first stage of opening the door 20, the curvature of the convex curved groove is smaller, the main movement of the door 20 is outward, at which time, both the rotation angle and forward distance of the door 20 are smaller, avoiding interference between this door 20 and another in a French door refrigerator 100 during the opening process. In the second stage of opening the door 20, the curvature of the convex curved groove is larger, the main movement of the door 20 is forward, at which time, the rotation angle and outward distance are smaller, avoiding interference with walls/cupboards at the pivot side. In the third stage of opening the door 20, the main movement of the door 20 is rotational, at which time, both the forward and outward distances are smaller, further increasing the door's 20 opening angle to facilitate users in viewing and accessing items inside the cabinet 30.

Further, in this embodiment, the rotating end of the first rocker 31a in the linkage assembly 3a is rotatably connected to the movable seat 2, and the swinging end of the first rocker 31a is slidably connected in the guide groove 4a. The rotating end of the second rocker 32a is rotatably connected to the movable seat 2. The rotating end of the third rocker 33a is rotatably connected to the fixed seat 1, and the swinging end of the third rocker 33a is rotatably connected to the swinging end of the second rocker 32a. The third rocker 33a crosses the first rocker 31a and is rotatably connected at the crossing point, thus, the linkage assembly 3a, the fixed seat 1, and the movable seat 2 together form a five-bar linkage structure.

The linkage assembly 3a forms a longer force arm, allowing the door 20 to move forward to a position far from the front end of the cabinet 30 during the opening process. Therefore, after applying the hinge 10a to a built-in refrigerator 100, the door 20 of the built-in refrigerator 100 can easily move to the front end of the wall/cupboard at the pivot side during the opening process, effectively avoiding interference between the door 20 and the wall/cupboard at the pivot side.

Specifically, the end of the guide groove 4a away from the pivot side of the hinge 10a is located on the side of the rotating end of the third rocker 33a that is away from the movable seat 2. In the closed state, the swinging end of the first rocker 31a is positioned on the side of the rotating end of the third rocker 33a away from the movable seat 2, enabling the linkage assembly 3a to switch between the folded and unfolded states. Thus, the linkage assembly 3a can control the transition of the door 20 between the closed and open states and control the movement trajectory of the door 20.

Further, the containment cavity 5a is located on the fixed seat 1 and opens towards the movable seat 2 to accommodate the linkage assembly 3a in its folded state, enhancing the appearance of the refrigerator 100.

In the second embodiment of this application, besides the aforementioned differences, all other aspects remain the same as in the first embodiment and will not be reiterated.

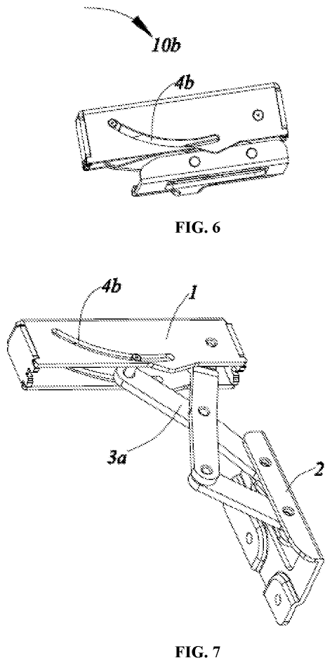

Referring to FIG. 6 and FIG. 7, shows a hinge 10b in the third embodiment of this application, The difference between the third embodiment and the second embodiment is that: the guide groove 4b is a concave curved groove that extends from the end away from the pivot side of the hinge 10b towards the movable seat 2 and towards the pivot side. In other words, as it approaches the pivot side, the curvature of the guide groove 4b gradually decreases.

In a specific embodiment, the entire guide groove 4b is curved groove.

Specifically, the curvature of the concave curved groove decreases as it approaches the pivot side. during the end of the linkage assembly 3 that cooperates with the guide groove 4b moves from the end of the concave curved groove away from the pivot side towards the pivot side, the movement ratio between the displacement in the first direction and the displacement in the second direction decreases progressively with the increase of the rotation angle of the movable seat 2. Consequently, in the first stage of opening the door 20, the curvature of the concave curved groove is larger, the main movement of the door 20 is forward, at which time, both the rotation angle and the outward distance of the door 20 are smaller, effectively avoiding interference with walls/cupboards at the pivot side. In the second stage of opening the doors, the curvature of the concave curved groove becomes smaller and gradually decreases, the main movement of the door 20 is outward, both the rotation angle and the forward distance of the door 20 are smaller, thereby reducing the space requirement in front of refrigerator 100 during the opening process. In the third stage of opening the door 20, the main movement of the door 20 is rotational, at which time, both the forward and outward distances are smaller, further increasing the door's 20 opening angle, facilitating user access to the contents within the cabinet 30.

Besides the above differences, all other aspects of the third embodiment are identical to those of the second embodiment and will not be repeated.

In a fourth embodiment of this application, the embodiment differs from the previous embodiment in that: the hinge comprise two sets of the described linkage assembly 3 disposed within the fixed seat 1 and arranged side by side along the height direction of the fixed seat 1, and two movable seats 2 respectively cooperating with the two sets of the linkage assembly 3. Integrating two of the hinge's fixed seats 1 can reduce the space required for installing the hinge and lower costs.

Additionally, the rotating shafts connected to the fixed seat 1 and coaxial with each other in the two sets of linkage assembly 3 are connected together by a sleeve, enhancing the operational stability of the hinge and the movement stability of the door 20.

It is understandable that the hinge in the fourth embodiment is suitable as a middle hinge, simultaneously connecting two doors 20 located on opposite sides of this middle hinge.

Further, please refer to FIG. 1, this application also provides a built-in refrigerator 100, which includes a cabinet 30, a door 20, and the above-mentioned hinges 10, 10a, 10b connecting between the cabinet 30 and the door 20. The fixed seat 1 of the hinges 10, 10a, 10b is fixedly connected to the cabinet 30, and the movable seat 2 of the hinges 10, 10a, 10b is fixedly connected to the door 20.

The structure of the hinges 10, 10a, 10b is as described above and will not be repeated here.

Further, the door 20 includes a refrigerator door 201 and a cupboard door 202 connected to the refrigerator door 201. The hinges 10, 10a, 10b are connected between the cupboard door 202 and the cabinet 30. During the opening and closing process of the cupboard door 202, it can drive the refrigerator door 201 to move synchronously.

In summary, the hinges 10, 10a, 10b of this application, by setting at least a portion of the guide grooves 4, 4a, 4b as curved groove, during the rotation of the movable seat 2 relative to the fixed seat 1, the movement ratio between the displacement in the first direction and the displacement in the second direction changes with the rotation angle of the movable seat 2. Thus, it is possible to adjust the displacement of the door 20 in the first and second directions during the opening process, and to control the movement trajectory of the door 20, enabling it to adapt to a variety of application scenarios.

The above examples are only to illustrate the technical solutions of this application and not to limit it. Despite the detailed explanation of the application with reference to preferred embodiments, such as the possibility of combining techniques from different embodiments to achieve corresponding effects, these are also within the scope of protection of this application. Those skilled in the art should understand that the technical solutions of this application can be modified or equivalently replaced without departing from the spirit and scope of the technical solutions of the application.

1. A hinge, comprising a fixed seat mounted on a cabinet, a movable seat mounted on a door, and a linkage assembly hinged between the fixed seat and the movable seat; wherein one of the movable seat and the fixed seat is provided with a guide groove, and at least one portion of the guide groove is a curved groove, and during the rotation of the movable seat relative to the fixed seat, the linkage assembly moves along the guide groove; alternatively, one of the movable seat and the fixed seat is provided with a guide groove that cooperates with the linkage assembly, and during the rotation of the movable seat relative to the fixed seat, the guide groove is used to guide the movable seat to move along intersecting first and second directions simultaneously; the movement ratio between displacements in the first direction and displacements in the second direction changes with the rotation angle of the movable seat.

2. The hinge of claim 1, wherein the guide groove is used to guide the movable seat to move along the intersecting first and second directions simultaneously; during the opening rotation of the movable seat relative to the fixed seat, the movement ratio between the displacement in the first direction and the displacement in the second direction gradually increases, or during the opening rotation of the movable seat relative to the fixed seat, the movement ratio between the displacement in the first direction and the displacement in the second direction gradually decreases.

3. The hinge of claim 1, wherein the guide groove is used to guide the movable seat to move along the intersecting first and second directions simultaneously; the first direction is a forward direction of the fixed seat towards the movable seat, and the second direction is a lateral direction towards the pivot side of the hinge, the first direction is perpendicular to the second direction.

4. The hinge of claim 1, wherein the guide groove is located on the movable seat; the portion of the guide groove away from the pivot side of the hinge is a convex curved groove, and the convex curved groove extends from the end away from the pivot side towards the pivot side and towards the fixed seat.

5. The hinge of claim 4, wherein the portion of the guide groove near the pivot side of the hinge is a straight groove, the convex curved groove is connected to the straight groove.

6. The hinge of claim 4, wherein the linkage assembly comprises:
a first rocker, the rotating end of the first rocker is rotatably connected to the fixed seat, and the swinging end of the first rocker is slidably connected in the guide groove;
a second rocker, the rotating end of the second rocker is rotatably connected to the fixed seat;
a third rocker, the rotating end of the third rocker is rotatably connected to the movable seat, and the swinging end of the third rocker is rotatably connected to the swinging end of the second rocker, and the third rocker crosses the first rocker and is rotatably connected at the crossing point.

7. The hinge of claim 6, wherein the rotating end of the second rocker is located on the side of the first rocker's rotating end that is away from the movable seat.

8. The hinge of claim 1, wherein the guide groove is located on the fixed seat; the guide groove is a convex curved groove that extends from the end away from the pivot side of the hinge towards the pivot side and towards the movable seat.

9. The hinge of claim 1, wherein the guide groove is located on the fixed seat; the guide groove is a concave curved groove that extends from the end away from the pivot side of the hinge towards the movable seat and towards the pivot side.

10. The hinge of claim 1, wherein the guide groove is located on the fixed seat; the linkage assembly comprises:
a first rocker, the rotating end of the first rocker is rotatably connected to the movable seat, and the swinging end of the first rocker is slidably connected in the guide groove;
a second rocker, the rotating end of the second rocker is rotatably connected to the movable seat;
a third rocker, the rotating end of the third rocker is rotatably connected to the fixed seat, and the swinging end of the third rocker is rotatably connected to the swinging end of the second rocker, and the third rocker crosses the first rocker and is rotatably connected at the crossing point.

11. The hinge of claim 10, wherein the end of the guide groove away from the pivot side of the hinge is located on the side of the third rocker's rotating end that is away from the movable seat.

12. The hinge of claim 1, wherein the movable seat or the fixed seat provided with the guide groove has a containment cavity, which is used to accommodate the linkage assembly in a folded state.

13. The hinge of claim 1, wherein the hinge comprises two sets of the linkage assembly disposed within the fixed seat and arranged side by side along the height direction of the fixed seat, and two movable seats respectively cooperating with the two sets of the linkage assembly.

14. The hinge of claim 13, wherein the rotating shafts connected to the fixed seat and coaxial with each other in the two sets of linkage assembly are connected together by a sleeve.

15. A built-in refrigerator, comprising a cabinet and a door, wherein the built-in refrigerator further comprises a hinge as described in claim 1.
